(19) United States
(12) Patent Application Publication
(10) Pub. No.: US 2015/0197612 A1
(43) Pub. Date: Jul. 16, 2015

(54) Novel Blowing Agents and Process

(71) Applicants: Eric Matthew Albee, Lambertville, NJ (US); Sandra Albee Keeley, Bensalem, PA (US)

(72) Inventors: Eric Matthew Albee, Lambertville, NJ (US); Sandra Albee Keeley, Bensalem, PA (US)

(21) Appl. No.: 14/153,525

(22) Filed: Jan. 13, 2014

(51) Int. Cl. C08J 9/00; C08J 9/10; C08J 9/08

(52) U.S. Cl. CPC C08J 9/0066; C08J 9/08; C08J 9/103; C08J 9/105; C08J 2323/06; C08J 2327/06; C08J 2325/06; C08J 2203/10; C08J 2203/02; C08J 2203/04

(57) ABSTRACT

The present invention is directed to the formulation and preparation of blowing agent powders and pelletized blowing agent concentrates that release water during the decomposition of the blowing agent components. The water released becomes chemically bonded to a dessicate such as calcium oxide (CaO). By chemically bonding the water generated by the decomposition of the blowing agent components, i.e., the sodium bicarbonate and benzenethiol sulphonic acid derivatives (OBSH), the foamed plastic develops a dramatically reduced cell size and hence smaller cell formation with improved surface quality. The dessicant materials are blended directly with the blowing agent components at levels that allow complete reaction with the water that is generated during the decomposition of the blowing agent components.

### FIELD OF THE INVENTION

The present invention generally relates to chemical compositions useful in the preparation of polymer plastics and materials that are incorporated in a wide variety of building materials and structural products. More specifically, the present invention relates to chemical blowing agents useful in the preparation and treatment of polymers, plastics and plastic compounds.

### BACKGROUND OF THE INVENTION

Chemical compounds known as blowing agents are substances which are capable of producing a cellular structure in a variety of materials that undergo hardening or phase transition (such as polymers, plastics and plastic compounds). They are used extensively in thermoplastic resins such as polyvinyl chloride resins, polyolefin resins, ethylene vinyl alcohol resins, rubbers and the like. They are usually effective when the blown material is in a liquid or molted state. Blowing agents include compressed gases that expand when pressure is released, soluble solids that leave pores when leached out, liquids that develop cells when they change to gases, and chemical agents that decompose or react under the influence of heat to form a gas.

Chemical blowing agents create a foamed polymer matrix, allowing the use of less material to produce lighter products of similar volume. These additives help optimize yield and cost, while providing consumers with environmentally friendly products. Plastic converters can therefore work towards more sustainable development, with solutions reducing the impact of products on the environment.

Moreover, U.S. Pat. No. 4,263,165 to Roos et. al. teaches a blowing agent combination comprising azodicarbonamide (AZO), zinc oxide and a benzenethiol sulphonic acid derivative. The patent states that “the formation of ammonia is greatly accelerated by the presence of water”. U.S. Pat. No. 5,045,570 to Mooney et. al. teaches a foamed product composition comprising a polymer, an additive such as fillers, flame retardants and polar resins and a blowing agent consisting of a polycarboxylic acid and an inorganic carbonate. The patent further teaches that the use of glyceryl monostearate to surface coat blowing agents makes them resistant to moisture absorption.

U.S. Pat. No. 6,399,201 to Maekawa et. al. discloses and claims a blowing agent powder with an azodicarbamide core having a particle diameter between 1 and 100 μm which is coated with at least one substance selected from the group consisting of oils and fats in liquid and solid state, hydrocarbons, and fatty acids, wherein said blowing agent powder is substantially anhydrous having a water content of lower than 0.03% by weight of benzenethiol sulphonic acid derizatives

U.S. Pat. No. 6,399,201 also to Maekawa et. al. discloses a blowing agent powder comprising with a particle diameter between 1 and 100μ which is coated with at least one substance selected from the group consisting of oils and fats in liquid and solid state, hydrocarbons, and fatty acids. The blowing agent powder is substantially anhydrous as it is treated with a surface-treating agent capable of removing surface water from the blowing agent selected from the group consisting of a coupling agent, an organic acid anhydride, an anhydrous inorganic compound, and a desiccant.

U.S. Pat. No. 6,355,698 also to Maekawa et al discloses and claims a process for producing a substantially anhydrous blowing agent powder, comprising a surface treatment to remove surface water from blowing agent powders. The process comprises the steps of treating a blowing agent powder consisting of at least one compound selected from the group consisting of azodicarbonamide (AZO), p,p′-oxybis(benzenesulfonyl hydrazide), dinitropentamethylenetetramine, p-toluenesulfonyl hydrazide and benzenesulfonyl hydrazide with a surface-treating agent capable of removing surface water from the blowing agent powder under conditions substantially free of a solvent. This is heated at a temperature of 30° C. or the decomposition temperature of the blowing agent powder during or after the treatment with the surface-treating agent to provide a substantially anhydrous blowing agent powder.

U.S. Pat. Nos. 5,609,892 and 5,234,963 to Garcia et. al. discloses compounding, encapsulating and pelletizing in a high melt resin carrier, a highly loaded concentration (5.0 to 70 wt %) of foaming agents which include an endothermic foaming agent, an exothermic foaming agent or a hybrid combination thereof such that when incorporated into a thermoplastic resin to produce a foamed product the agents will chemically react to form carbon dioxide, nitrogen or hydrogen or mixtures thereof as the active foaming gas. The dessicants are used to prevent caking of blowing agent powders. More specifically, in examples 8, 9, 10, 11, 12 and 13 the use of 0.5 to 0.25% of CaO is disclosed wherein it is stated that “ . . . in addition to these conditions, CaO was added to entrap any water in the foaming agent components.”

The prior art processes often produce a substantially anhydrous blowing agent by treating a blowing agent powder such as azodicarbonamide, p,p′-oxybis(benzenesulfonyl hydrazide, (OBSH), or benzenethiol sulfonic acid derivatives with a surface-treating agent capable of removing surface water from the blowing agent powder under conditions substantially free of a solvent, and in combination with a dessicant selected from the group consisting of calcium oxide (CaO), magnesium oxide (MgO), aluminum oxide (AIO) and organic acid anhydrides, heating the mixture to a temperature of 30° C. which is the decomposition temperature of the blowing agent powder.

Therefore, it is arguably well known that sodium bicarbonate and OBSH, by themselves or in combination with AZO, activated AZO systems and/or citric acid, generate water during their decomposition. It is also known that water absorbed by these components will develop caking of the powders and that water increases the generation of ammonia during the decomposition of AZO. It is not obvious from prior art however, that chemically bonding the water generated during the decomposition of the blowing agents, dramatically reduces cell size, improves cell uniformity and the surface quality of foamed polymers, plastics and plastic components.

### SUMMARY OF THE INVENTION

The present invention is directed to the formulation and preparation of blowing agent powders and pelletized blowing agent concentrates that release water during the decomposition of the blowing agent components. The water released becomes chemically bonded to a dessicant such as calcium oxide (CaO). By chemically bonding the water generated by the decomposition of the blowing agent components, i.e., the sodium bicarbonate and p,p′-oxybis(benzenesulfonyl hydrazide (OBSH) the foamed plastic develops a dramatically reduced cell size and hence smaller cell formation with improved surface quality. The desiccant materials are blended directly with the blowing agent components at levels that allow complete reaction with the water that is generated during the decomposition of the blowing agent components.

### DETAILED DESCRIPTION OF THE INVENTION

The blowing agent powders and pelletized blowing agent concentrates of the present invention release water during the decomposition of the blowing agent components which in this case comprise the alkali carbonates, (sodium bicarbonate) and benzenethiol sulphonic acid derivatives (OBSH). The water released becomes chemically bonded to a dessicant such as calcium oxide (CaO), magnesium oxide (MgO), aluminum oxide (AlO), and organic acid anhydrides, among others. By chemically bonding the water generated by the decomposition of the blowing agent components, i.e., the sodium bicarbonate and OBSH, the foamed plastic develops a dramatically reduced cell size and hence smaller cell formation with improved surface quality. The dessicant materials are blended directly with the blowing agent components at levels that allow complete reaction with the water that is generated during the decomposition of the blowing agent components.

A surprising and unexpected advantage of this is that by chemically bonding the water generated by the decomposition of the blowing agents to a dessicant, the formation of steam is avoided. If steam was generated, since it is not soluble in the polymer melt, the polymer product exiting the die would develop large cells prior to and during the exit of the product from the die. It is well known in the art that both sodium bicarbonate and OBSH generate water during their decomposition.

A desiccant is a hygroscopic substance that induces or sustains a state of dryness (desiccation) in its local vicinity in a moderately well-sealed container. Commonly encountered pre-packaged desiccants are solids, and work through the absorption or adsorption of water, or a combination of the two. Desiccants for specialized purposes may be in forms other than solid, and may work through other principles, such as chemical bonding of water molecules. Pre-packaged desiccants are most commonly used to remove excessive humidity that would normally degrade or even destroy products sensitive to moisture. Some compounds commonly used as desiccants are: silica gel, calcium sulfate, calcium chloride, montmorillonite clay, and molecular sieves.

Sodium bicarbonate and OBSH have been used for years as blowing agents by themselves or in combination with Azo—compounds, activated Azo systems and/or citric acid. Azo compounds are those compounds which bear the functional group R—N═N—R′, in which R and R′ can be either aryl or alkyl. IUPAC defines Azo compounds as: “derivatives of diazene (diimide), HN═NH, wherein both hydrogens are substituted by hydrocarbyl groups, e.g. PhN═NPh azobenzene or diphenyldiazene. The more stable derivatives contain two aryl groups. The N═N group is called an azo group.

When para-benzenethiol sulphonic acid (OBSH) derivatives decompose or are activated, they generate nitrogen gas (N₂) and water (H₂O) In the first step of OBSH activation (decomposition) four (4) nitrogen molecules and two (2) water molecules are generated. In the final step, an additional water molecule is produced. Sodium bicarbonate (NaCO₃) on the other hand, generates one (1) molecule of carbon dioxide (CO₂) and one (1) molecule of water from two molecules of sodium bicarbonate. Calcium oxide reacts with water to form calcium hydroxide. The calcium hydroxide thus formed will not release water (H₂O) unless it is heated to a temperature of 300° C. which is well above the process temperatures for most PVC plastics. In summary, the reactions with respect to sodium bicarbonate are as follows:

2NaHCO₃→CO₂+H₂O+Na₂CO₃ 1)

CaO+H₂O→_Ca(OH)₂+Heat 2)

The present invention has recognized that both carbon dioxide (CO₂) and nitrogen gas are soluble in a polyvinyl chloride melt if placed under pressure. Water however, is not soluble in the PVC resin at any pressure. It was surprisingly and unexpectedly discovered that by chemically bonding the water in the reactions set forth above during the processing of the polyvinyl chloride resin, foaming of the product will be delayed. That is to say, by carrying the PVC extrusion process of the melt at pressures above 3000 psi, the carbon dioxide (CO₂) and nitrogen (N₂) gases formed are solubilized into the melt. These are released however, upon exiting the extruder since the temperature and pressure is then dramatically reduced. This results in the formation of bubbles in the final product. Chemically bonding the water during the extrusion process dramatically reduces the cell size of the foamed product and reduces the core color of the thick PVC profiles and sheets. The novel blowing agent compositions of the present invention also allow for the production of an expanded polymeric material that has an improved uniform cell structure with reduced discoloration.

The blowing agent powder which can be used in the present invention is selected from conventionally known blowing agents. Examples include blowing agents, for example, azodicarbonamide (ADCA), hydrazodicarbonamide (HDCA), p,p′-oxybis(benzenesulfonyl hydrazide) (OBSH), dinitropentamethylenetetramine (DPT), p-toluenesulfonyl hydrazide (TSH), benzenesulfonyl hydrazide (BSH), 5-phenyltetrazole (5-PT), and the like, and salts of these with an alkaline earth metal (e.g., calcium, barium, or strontium) or with aluminum, and the like; and inorganic blowing agents, for example, sodium bicarbonate, sodium hydrogen carbonate, anhydrous monosodium citrate, and the like. Among these, preferred are ADCA, OBSH, DPT, TSH, BSH, 5-PT, and the like; and salts of these with sodium, calcium, barium, strontium, aluminum, and the like. Especially preferred is, azodicarbonamide (ADCA), p,p′-oxybis(benzenesulfonyl hydrazide (OBSH) and sodium bicarbonate.

The desiccant that is mixed with the blowing agent powder is selected from the group consisting of alkali carbonates and organic acid anhydrides. The dessicant is mixed with the blowing agent powder under conditions substantially free of a solvent to provide a substantially anhydrous blowing agent powder. Alkali carbonates useful in the practice of the present invention include calcium oxide, magnesium oxide, aluminum oxide and mixtures thereof. Organic acid anhydrides useful as desiccants in the practice of the present invention may be selected from the group consisting of acetic anhydride, maleic anhydride, formic anhydride and mixtures thereof. The amount of the dessicant that is blended with the blowing agent powder is preferably selected on a molar basis so that the amount is sufficient to react with all the water that is produced during the decomposition of the blowing agent powder.

The following examples are provided to more specifically set forth and define the process of the present invention. It is recognized that changes may be made to the specific parameters and ranges disclosed herein and that there are a number of different ways known in the art to change the disclosed variables. And whereas it is understood that only the preferred embodiments of these elements are disclosed herein as set forth in the specification and drawings, the invention should not be so limited and should be construed in terms of the spirit and scope of the claims that follow herein.

All blowing agent powder blends have been made into pelletized blowing agent concentrates and evaluated in the respective plastics. The test results are the same as the blowing agent powder blends.

Pelletized Concentrates were made using both a single screw and twin screw extruder. Concentrates can be made using processing and processes commonly known in the art. A concentrate carrier (plastic) that is suitable and compatible with the plastic is used to make the blowing agent concentrate.

### Example 1

Pelletized Concentrates were made using both a single screw and twin screw extruder. Concentrates can be made using processing and processes commonly known to the industry. A Concentrate Carrier (plastic) that is suitable and compatible with the plastic is used to make the blowing agent concentrate.

An extrusion evaluation of two samples of polystyrene foam comprising a blowing agent powder of the prior art (sample A) was compared to an extruded polystyrene foam comprising the present invention (sample B).

### Foaming Low Density Polyethylene

Two blowing agent powder blends were made, using a small (5 liter) high intensity mixer. Each blend was mixed for the same amount of time and under the same conditions to assure uniform distribution of all components. After blending, the two blowing agent powder blends were mixed with low density polyethylene resin (LDPE). The LDPE had a melt index of 1.6 grams/10 minutes, and a density of 0.918.

The blends of blowing agent powder and LDPE resin were extruded and foamed using a one inch single screw extruder, 24 inches in length, and a 9 mm rod die. Extrusion conditions were as follows:
Heater Zone 1-340° F.
   2-340° F.
   3-340° F.
   4-340° F.
Screw RPM rate at 30

### Blowing Agent Blends

### Blend A

Blend A was made using the following formulation:
88% Sodium Bicarbonate—technical fine grade
12% Monosodium Citrate—technical grade

The resulting blowing agent blend has a gas yield of 133 ccs./gram upon activation at 220° C. This blend was blended with LDPE at 1% addition.

### Blend B

Blend B was made using the following formulation:
61.6% Sodium Bicarbonate—technical fine grade
8.4& Monosodium Citrate—technical grade
30% Calcium Oxide (CaO)

The resulting blowing agent blend had a gas yield of 99 ccs./gram upon activation at 220° C. This blend was blended with LDPE at 1.4% addition.

The amount of each blowing agent blend used to blend with the LDPE resin was calculated to assure that the same amount of gas was available for foaming during the extrusion process. Foamed rods made from both blowing agent powder blends (A and B) developed the same density (0.65 grams/cc). However, all samples made using the blowing agent powder blend B had a much more uniform cell structure; smaller cell size and improved surface quality.

### Example 2

### Foaming Rigid Polyvinyl Chloride (PVC)

Two blowing agent powder blends were made using a small (5 liter) high intensity mixer. Each blend was mixed for the same amount of time and under the same conditions to assure uniform distribution of all components. After blending, the two blowing agent powder blends were mixed, using a high intensity mixer, with a PVC dry blend formulated for the production of foamed rigid PVC profile. The K-value of the PVC used in the dry blend was 56.

The blends of blowing agent powder and PVC dry blend were extruded and foamed using a 2½ inch single screw extruder, 24 to 1 in length, and a 0.5 inch by 6.0 inch profile die. Extrusion conditions were as follows:
Heater Zone 1-340° F.
   2-360° F.
   3-370° F.
   4-380° F.
Adaptor 340° F.
Die 1-320° F.
   2-320° F.
   3-320° F.

### Blowing Agent Blends

### Blend A

Blend A was made using the following formulation:
70.6% Sodium Bicarbonate—technical fine grade
29.4% Activated AZO (Forte—cell 247)

The resulting blowing agent blend has a gas yield of 162 ccs./gram upon activation at 220° C. This blend was blended with the PVC dry blend at 1.5% addition.

### Blend B

Blend B was made using the following formulation:
44.5% Sodium Bicarbonate—technical fine grade
18.5% Activated AZO (Forte—cell 247)
37.05 Calcium Oxide (CaO)

The resulting blowing agent blend has a gas yield of 102 ccs./gram upon activation at 220° C. This was blended with the PVC dry blend at 2.37% addition.

The amount of each blowing agent mixture used to blend with the PVC dry blend was calculated to assure that the same amount of gas was available for foaming during the extrusion process. These improved characteristics resulted in an improved, overall superior product compared to those PVC products known in the art.

### Example 3

### Foaming Rigid PVC (Sheet)

A rigid PVC sheet was formed following the same procedure as that described in example 2 above except that
The PVC dry blend was formulated for the production of foamed rigid PVC sheet.
The sheet was extruded and foamed using a parallel twin screw extruder with a 48 inch wide sheet die. Extrusion conditions were as follows:
Zone 1-345° F.
   2-355° F.
   3-355° F.
   4-300° F.
   5-300° F.

### Blowing Agent Blends

### Blend A

Blend A was made using the following formulation:
52% Sodium Bicarbonate—technical fine grade
36% AZO
12% OBSH

The resulting blowing agent blend has a gas yield of 192.8 ccs./grams upon activation at 220° C. This was blended with the PVC dry blend at 0.6% addition.

### Blend B

Blend B was made using the following formulation:
39% Sodium Bicarbonate—technical fine grade
27% AZO
8.5% OBSH
25.5% Calcium Oxide (CaO)

The resulting blowing agent blend has a gas yield of 144.6 ccs./grams upon activation at 220° C. This blend was blended with the PVC dry blend at 0.8% addition.

The amount of each blowing agent powder mixed with the PVC dry blend was calculated to assure that the same amount of gas was available for foaming during the extrusion process. The foamed one inch thick sheet, made from both blowing agent powder blends (A & B), developed the following densities: A=0.66 grams/cc.; B=0.61 grams/cc. However, all samples made using blowing agent powder Blend B, had a much smaller and uniform cell structure, no voids, significantly less core yellowing and an improved surface. These characteristics resulted in an improved, overall superior product compared to those PVC products known in the art.

### Example 4

### Foaming Polystyrene

The formulation procedure followed in example 4 was the same as that used in example 1, except that:
The two blowing agent powder blends were mixed in combination with High Impact Polystyrene Resin (HIPS). The HIPS had a melt index of 2 grams/10 minutes.
The blends were extruded and foamed using a one inch single screw extruder, 24 to 1 in length and a 9 mm rod die. Extrusion conditions were as follows:
Heater Zone 1-320° F.
   2-360° F.
   3-380° F.
   4-300° F.
Screw RPM rate—30

### Blowing Agent Blends

### Blend A

Blend A was made using the following formulation:
88% Sodium Bicarbonate—technical fine grade
12% Citric Acid—technical fine grade

The resulting blowing agent mixture has a gas yield of 140 ccs./grams upon activation at 220° C. This was then blended with HIPS at 1% addition.

### Blend B

Blend B was made using the following formulation:
61.6% Sodium Bicarbonate—technical fine grade
8.4% Citric Acid—technical fine grade
30% Calcium Oxide (CaO)

The resulting blowing agent blend had a gas yield of 98 ccs./grams upon activation at 220° C. This blend was further combined with HIPS at 1.4% addition.

The amount of each blowing agent blend mixed with HIPS resin was calculated to assure that the same amount of gas was available for foaming during the extrusion process.

Foamed rods made from both blowing agent powder blends (A and B) developed the same density (0.68 grams/cc). However, all samples made using blowing agent powder Blend B had a much more uniform cell structure, smaller cell size and improved surface. These improved characteristics resulted in an improved, overall superior product compared to those polystyrene products known in the art.

What is claimed is:

1. A process for producing a substantially anhydrous blowing agent powder comprising the steps of treating a blowing agent selected from the group comprising p,p′-oxybis(benzenesulfonyl hydrazide), sodium bicarbonate, azodicarbonamide and mixtures thereof with at least one dessicant selected from the group consisting of alkali carbonates and organic acid anhydrides under conditions substantially free of a solvent to provide a substantially anhydrous blowing agent powder.

2. The process of claim 1 wherein said alkali carbonate is selected from the group consisting of calcium oxide (CaO), magnesium oxide (MgO), aluminum oxide (AlO), and mixtures thereof.

3. The process of claim 2 wherein said organic acid anhydride is selected from the group consisting of acetic anhydride, maleic anhydride, formic anhydride and mixtures thereof.

4. The process of claim 3 wherein the blowing agent compound and powder is mixed at a temperature sufficient to result in the decomposition of the blowing agent thereby releasing water there from.

5. The process of claim 4 wherein said dessicant is added in an amount sufficient to react with all of the water that is produced from the decomposition of the blowing agent.
